(19) United States
(12) Patent Application Publication
(10) Pub. No.: US 2015/0139102 A1
(43) Pub. Date: May 21, 2015

(54) BUILDING HS-SICHS IN MULTI-CARRIER TD-HSDPA SYSTEMS

(71) Applicant: QUALCOMM Incorporated, San Diego, CA (US)

(72) Inventors: Ruiming Zheng, San Diego, CA (US); Jiming Guo, San Diego, CA (US); Jianqiang Zhang, San Diego, CA (US)

(21) Appl. No.: 14/403,809

(22) PCT Filed: Jul. 2, 2012
(86) PCT No.: PCT/CN2012/078044

§ 371 Date: Feb. 4, 2015

(51) Int. Cl. H04L 5/00

(52) U.S. Cl. CPC H04L 5/0057; H04L 5/0055
USPC 370/329

(57) ABSTRACT

In High-Speed Downlink Packet Access (HSDPA) communications in a Time Division Synchronous Code Division Multiple Access (TD-SCDMA) system (called TD-HSDPA), the payload of two High-Speed Shared Information Channels (HS-SICHs) may be bundled into one HS-SICH channel by reusing the unused uplink synchronization shift (SS) for power control purposes. Thus, the HS-SICH spreading factor (SF) 16 code channel overhead may be reduced by 50%.

### BACKGROUND

1. Field

Aspects of the present disclosure relate generally to wireless communication systems, and more particularly, to building high speed shared information control channels (HS-SICHs) in multi-carrier time division high speed downlink packet access (TD-HSDPA) systems.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Packet Access (HSPA), which provides higher data transfer speeds and capacity to associated UMTS networks. HSPA is a collection of two mobile telephony protocols, High Speed Downlink Packet Access (HSDPA) and High Speed Uplink Packet Access (HSUPA) that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

Offered is a method of multicarrier wireless communication. The method includes combining channel quality reports for a first carrier and a second carrier into a single reporting payload. The method also includes transmitting the single reporting payload to a base station.

Offered is an apparatus for multicarrier wireless communication. The apparatus includes means for combining channel quality reports for a first carrier and a second carrier into a single reporting payload. The apparatus also includes means for transmitting the single reporting payload to a base station.

Offered is a computer program product. The computer program product includes a non-transitory computer-readable medium having non-transitory program code recorded thereon. The program code includes program code to combine channel quality reports for a first carrier and a second carrier into a single reporting payload. The program code further includes program code to transmit the single reporting payload to a base station.

Offered is an apparatus configured for wireless communication. The apparatus includes a memory and a processor(s) coupled to the memory. The processor(s) is configured to combine channel quality reports for a first carrier and a second carrier into a single reporting payload. The processor(s) is further configured to transmit the single reporting payload to a base station.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE 350 in a telecommunications system.

FIG. 4 is a block diagram conceptually illustrating carrier frequencies in a multi-carrier TD-SCDMA communication system.

FIG. 5 is a block diagram conceptually illustrating single carrier communications and associated timing according to one aspect of the present disclosure.

FIG. 6 shows a structure of a burst for a high speed shared information channel (HS-SICH).

FIG. 7 is a block diagram conceptually illustrating multiple carrier communications and associated timing in an aspect of the present disclosure.

FIG. 8 shows a mapping of two downlink carrier high speed shared information control channels (HS-SICHs) to one traditional HS-SICH channel according to one aspect of the present disclosure.

FIG. 9 is a block diagram illustrating a method for building high speed shared information control channels (HS-SICHs) in multi-carrier time division high speed downlink packet access (TD-HSDPA) systems according to one aspect of the present disclosure.

FIG. 10 is a diagram illustrating an example of a hardware implementation for an apparatus employing a processing system.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

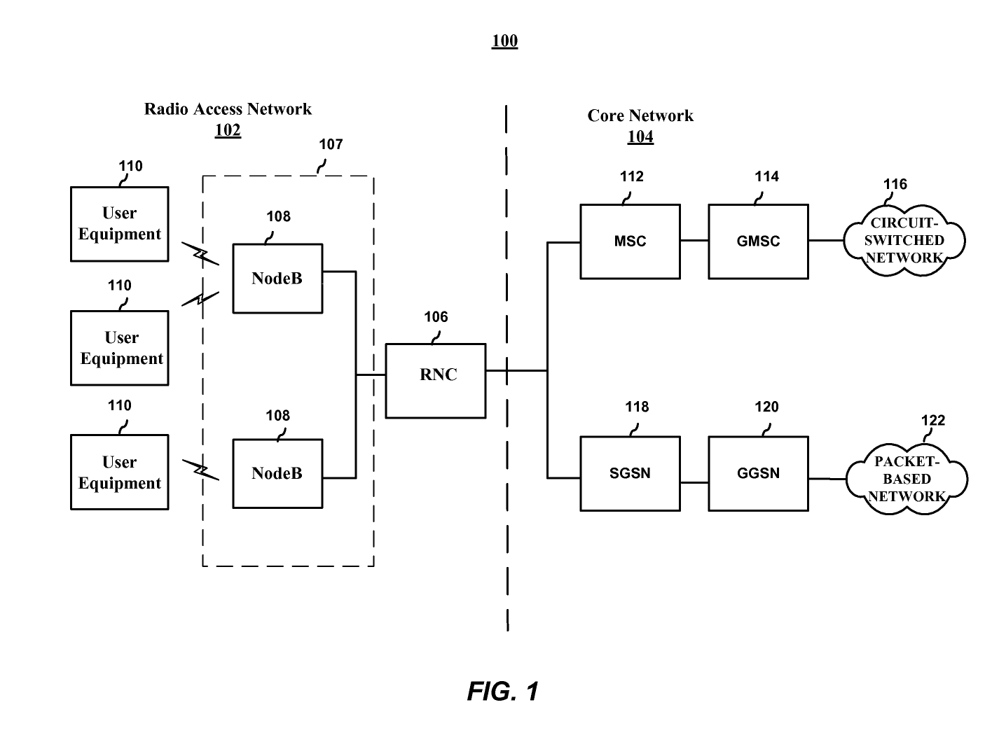

Turning now to FIG. 1, a block diagram is shown illustrating an example of a telecommunications system 90. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

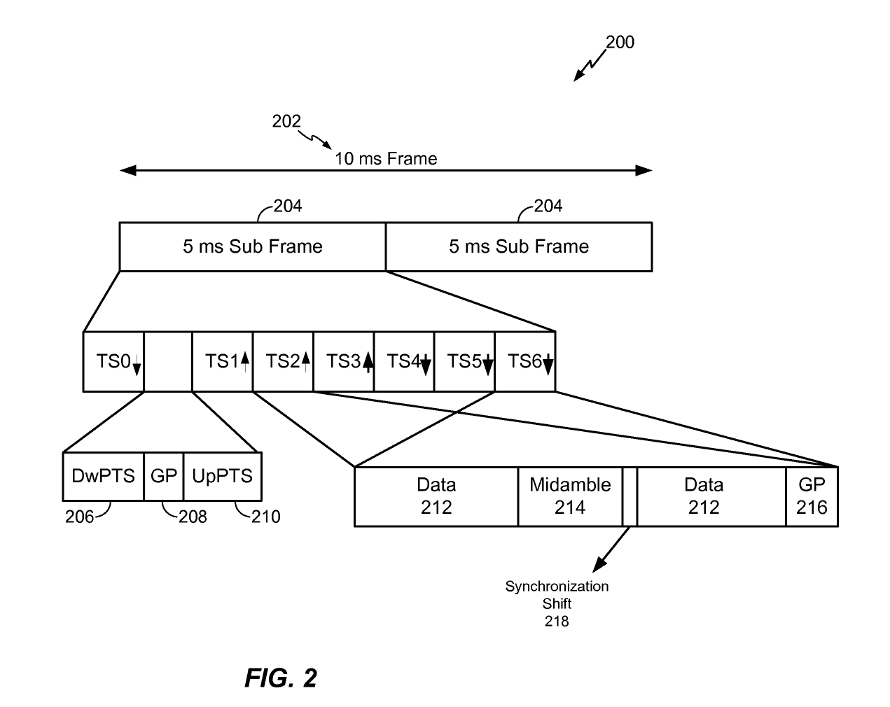

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including Synchronization Shift (SS) bits 218. Synchronization Shift bits 218 only appear in the second part of the data portion. The Synchronization Shift bits 218 immediately following the midamble can indicate three cases: decrease shift, increase shift, or do nothing in the upload transmit timing. The positions of the SS bits 218 are not generally used during uplink communications.

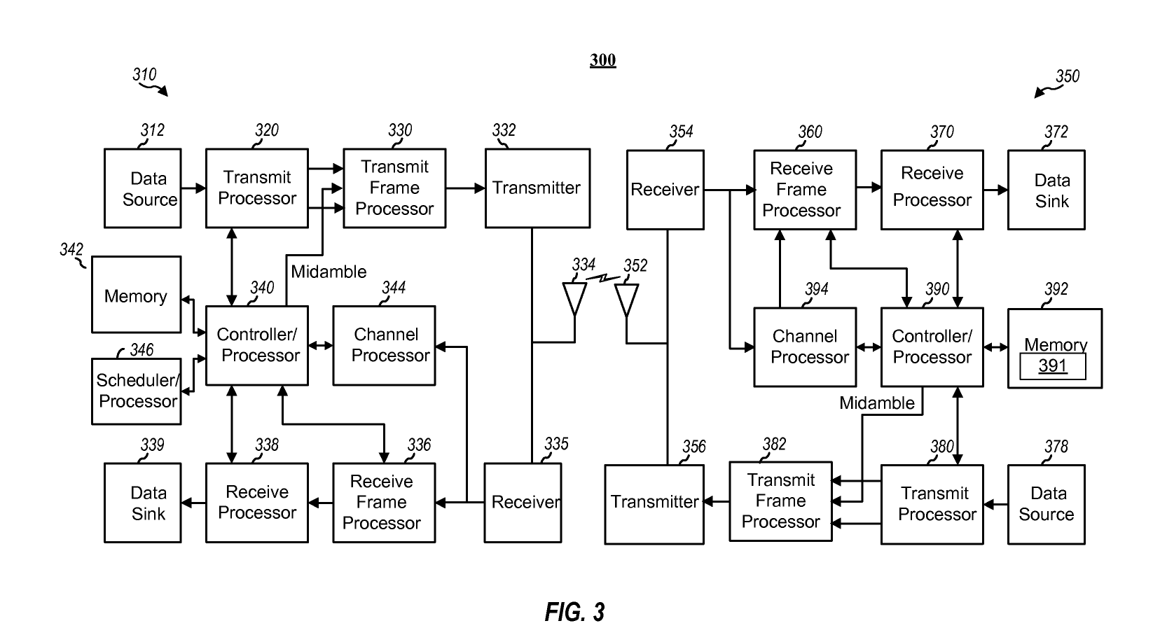

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

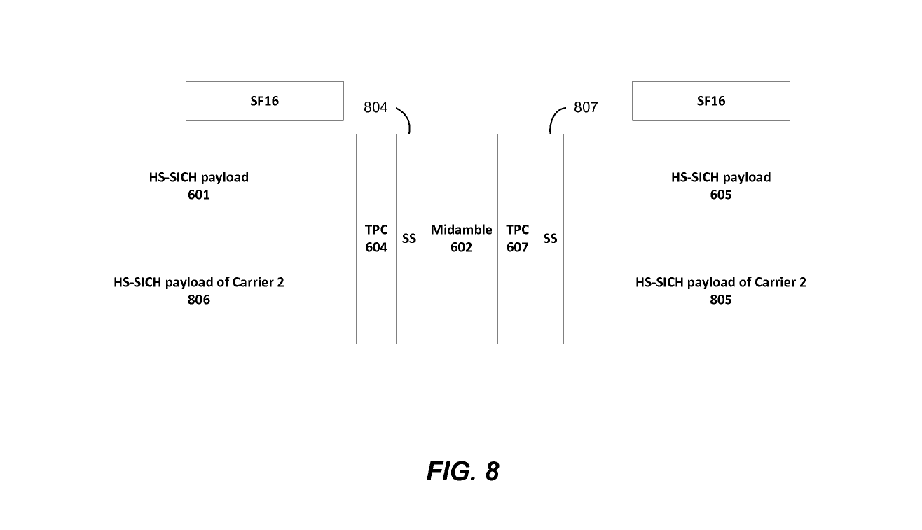

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The processor 340/390 and/or other processors and modules at the node B 310/UE 350 may perform or direct the execution of the functional blocks illustrated in FIG. 8. The computer readable media of memories 342 and 392 may store data and software for the node B 310 and the UE 350, respectively. For example, the memory 392 of the UE 350 may store multicarrier module 391 which, when executed by the controller/processor 390, configures the UE 350 for building high speed shared information control channels (HS-SICHS) in multi-carrier time division high speed downlink packet access (HSDPA) systems as described. A scheduler/processor 346 at the node B 310 may be used to allocate resources to the UEs and schedule downlink and/or uplink transmissions for the UEs.

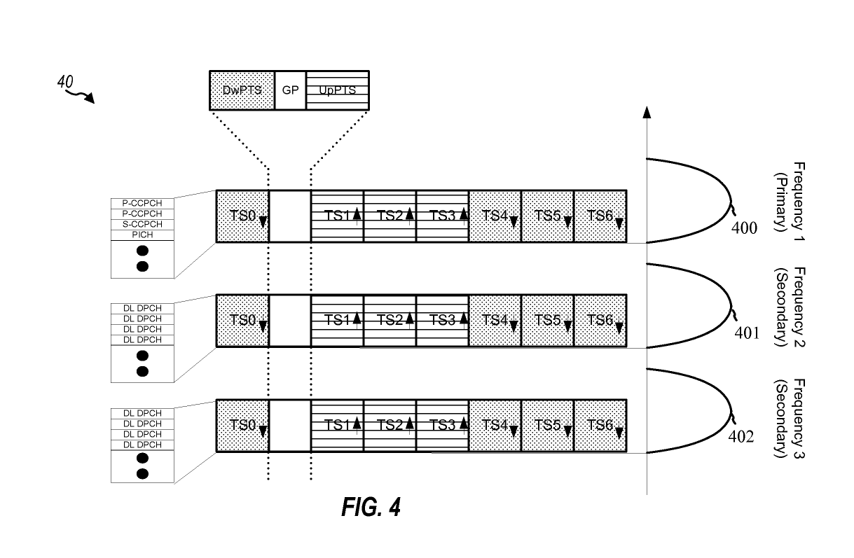

In order to provide more capacity, the TD-SCDMA system may allow multiple carrier signals or frequencies. Assuming that N is the total number of carriers, the carrier frequencies may be represented by the set {F(i), i=0, 1, . . . , N−1}, where the carrier frequency, F(0), is the primary carrier frequency and the rest are secondary carrier frequencies. For example, a cell can have three carrier signals whereby the data can be transmitted on some code channels of a time slot on one of the three carrier signal frequencies. FIG. 4 is a block diagram conceptually illustrating carrier frequencies 40 in a multi-carrier TD-SCDMA communication system. The multiple carrier frequencies include a primary carrier frequency 400 (F(1)), and two secondary carrier frequencies 401 and 402 (F(2) and F(3)). In such multi-carrier systems, the system overhead is transmitted on the first time slot (TS0) of the primary carrier frequency 400. In the first time slot (TS0) of the primary carrier frequency 400, the Primary Common Control Physical Channel (P-CCPCH), the Secondary Common Control Physical Channel (S-CCPCH), the Paging Indicator Channel (PICH), and the like are transmitted. The traffic channels (e.g., Downlink Dedicated Physical Channels (DL DPCHs)) may then be carried on the remaining time slots (TS4-TS6) of the primary carrier frequency 400 and on all downlink time slots (TS0 and TS4-TS6) of the secondary carrier frequencies 401 and 402. Therefore, in such configurations, a UE will receive system information and monitor the paging messages on the primary carrier frequency 400 while transmitting and receiving data on either one or all of the primary carrier frequency 400 and the secondary carrier frequencies 401 and 402.

### Building HS-SICHS in Multi-Carrier TD-HSDPA Systems

In current time division high speed downlink packet access (TD-HSDPA) systems, a base station or node B 310 transmits on a High-Speed Shared Control Channel (HS-SCCH) directed towards the UE 350 when the node B desires to schedule a particular UE for data communication. After a defined number of time slots, e.g., five time slots, following the HS-SCCH transmission, a scheduled UE 350 receives a corresponding data packet on the High-Speed Physical Downlink Shared Channel (HS-PDSCH). The data packet attributes (payload size, modulation format and a packet resource utilization (time/codes)) are as specified in the HS-SCCH communication to the UE. After a defined number of time slots, e.g., nine time slots, after the received data packet, the UE may uplink feedback and channel quality index (CQI) information on the High-Speed Shared Information Channel (HS-SICH) to the serving node B. The generation of CQI may be based on a particular received signal-to-noise ratio (SNR) or other metric. Along with the CQI information, the UE feedbacks to the serving node B the highest available data rate in terms of block size and modulation format that the UE could reliably receive assuming the same code, time, and power resource allocated to the received data packet.

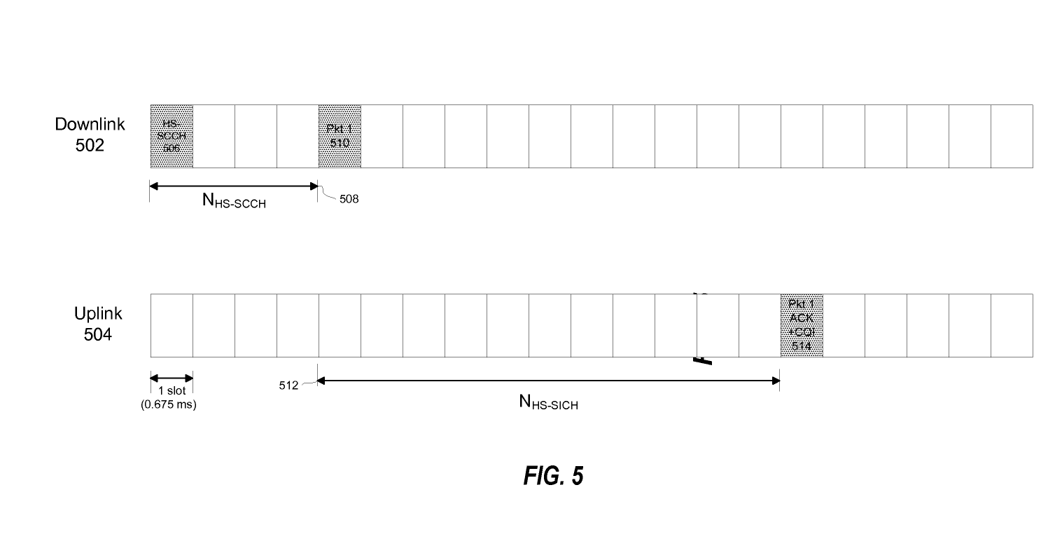

FIG. 5 illustrates communications and associated timing in a communication system. In particular, FIG. 5 illustrates downlink 502 and uplink 504 time slots. Generally, in a time division high speed downlink packet access (TD-HSDPA) system 500, a physical layer process for high-speed downlink packet-switched data transmission may include multiple aspects. In one aspect, upon scheduling a particular UE, the node B transmits on the HS-SCCH directed towards the UE 350 in one subframe 506. In one aspect, after a defined number of slots (N_{HS-SCCH}) 508 (e.g., five slots) after HS-SCCH transmission 506, the node B 310 may transmit the corresponding data packet in HS-PDSCH 510 according to the payload size, modulation format, and resource utilization (time/code space) specified in the HS-SCCH 506. After receiving the data packet, the UE 350 will attempt to decode the HS-PDSCH packet 510. After a defined number of slots (N_{HS-SICH}) 512 following the sending of the data packet (e.g., 9 slots), the UE 350 may transmit to the node B 310, the ACK/NACK acknowledgement/negative acknowledgment (ACK/NACK) message 514 for the data packet 510 along with CQI information.

The CQI (including transport block size (TBS) and modulation scheme) and packet ACK/NACK information are transmitted via the HS-SICH channel using one spreading factor (SF) 16 channel. In one aspect, such as depicted in FIG. 5, only an active UE 350 may provide CQI results. As such, the aspect of CQI transmission may result in lower system throughput and airlink utilization in the downlink due to the lack of adequate channel information at the node B scheduler.

Due to the coexistence of other channels such as the Dedicated Physical Channel (DPCH), the midamble shift for each time slot is assigned as eight in the current TD-SCDMA network configuration. Thus, every two SF-16 channels are transmitted together as they are mapped to the same midamble shift. As a result, at least two code channels are typically used for UE uplink transmission.

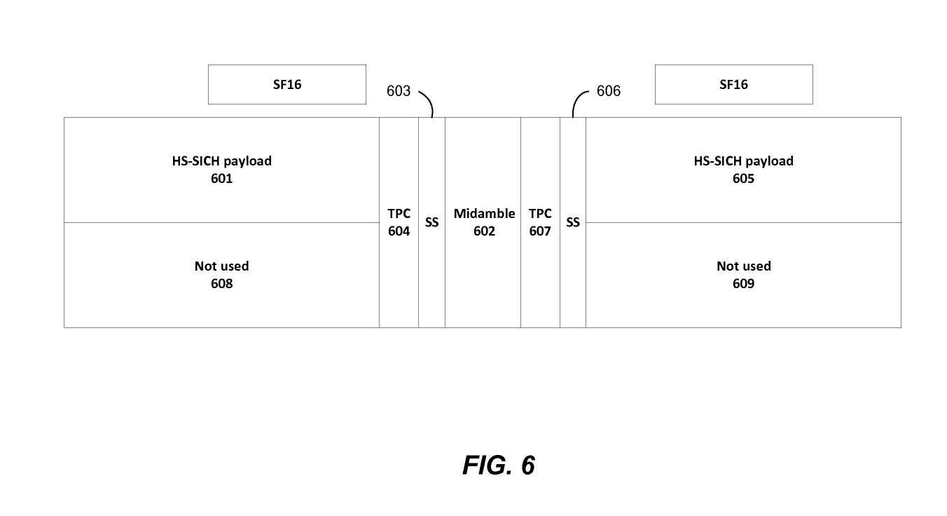

The transmission of HS-SICH over two SF-16 code channels is shown in FIG. 6. In particular, FIG. 6 shows a structure of a burst for a traditional HS-SICH. A duration of one burst is one time slot. The HS-SICH is an uplink shared physical channel corresponding to a high speed downlink shared channel (HS-DSCH), and is used to transmit a channel quality indicator (CQI) or an ACK/NACK signal for Hybrid Automatic Repeat Request (HARQ) operations. A burst of the traditional HS-SICH can include two HS-SICH payloads 601 and 605 where each payload is within a data section of each SF-16 channel. The burst of the traditional HS-SICH also includes a midamble 602, two transmit power controls (TPCs) 604 and 607, two synchronization shift (SSs) 603 and 606 and two unused data transmitting sections 608 and 609. The HS-SICH payloads 601 and 605 are used to transmit data (e.g., the CQI and the ACK/NACK signal). The midamble 602 is used to identify UEs that use the same time slots and/or to estimate a channel for data demodulation. The SSs 603 and 606 are used to transmit a command for adjusting synchronization when an out-of-synchronization condition occurs due to, for example, changes in a distance between a UE 350 and a node B 310 or due to other reasons. The TPCs 604 and 607 are used to control downlink power of the base station. The portions 608 and 609 are unused due to the code channel restrictions discussed above.

In the case of traditional multi-carrier High Speed Downlink Shared Channel (HS-DSCH) reception, a UE is assigned an independent HS-SCCH/HS-SICH pair for scheduling and CQI/ACK/NACK information delivery, which leads to increased HS-SICH channel code channel consumption for one UE. In addition, based on existing TD-HSDPA configurations, the CQI information of each UE is transmitted only when the UE is scheduled. This limitation on CQI transmission results in lower system throughput. Thus, in the traditional HS-SICH, the UE is configured to feedback CQI information of a single carrier via the HS-SICH. Reporting CQI information for only a single carrier via the HS-SICH results in unused data sections (e.g., two unused data transmitting sections 608 and 609) for HS-SICH payload.

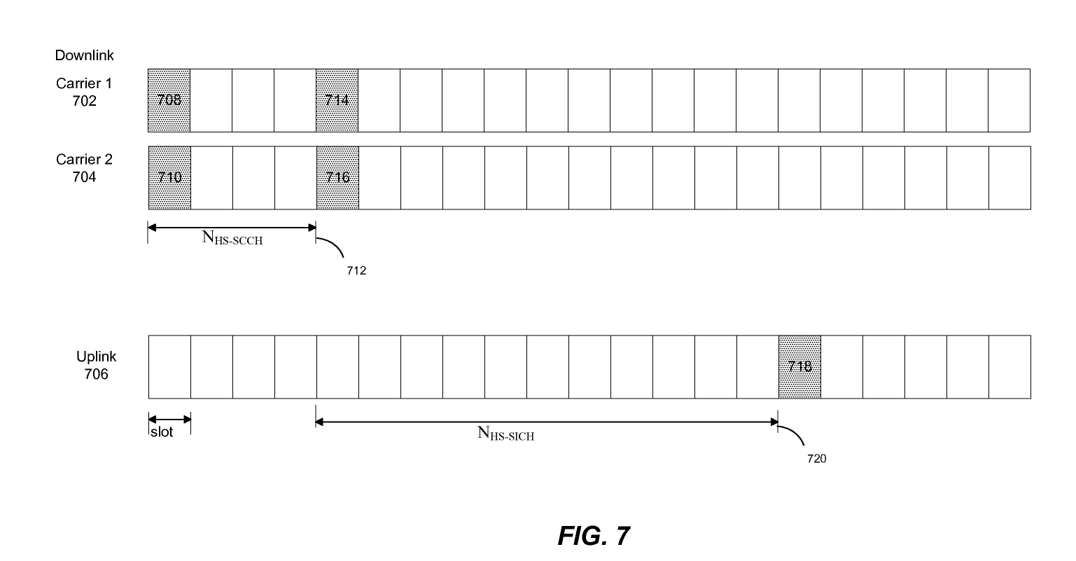

FIG. 7 is a block diagram conceptually illustrating a multicarrier communication and associated timing in an aspect of the present disclosure. In particular, FIG. 7 illustrates time slots for downlink 702 of carrier 1, time slots for downlink 704 of carrier 2 and uplink 706. The features of each downlink 702 or 704 of carriers 1 and 2, respectively, are similar to the features of the downlink 502 described with respect to the single carrier example of FIG. 5. Similarly, the features of the uplink 706 is similar to the features of the uplink 504 described with respect to FIG. 5. For example, the node B 310 transmits a HS-SCCH directed towards the UE 350 in one subframe 708 for carrier 1 and in another subframe 710 for carrier 2. After a defined number of slots (N_{HS-SCCH}) 712 following HS-SCCH transmissions 708 and 710, corresponding data packets 714 for carrier 1 and 716 for carrier 2 are transmitted to UE. The UE 350 may then transmit CQI and ACK/NACK 718 for each particular data packet on the uplink 706 after a certain number of slots (N_{HS-SICH}) 720.

In a traditional multicarrier configuration, a UE reports CQI and ACK/NACK feedback information for each carrier separately. Thus, each UE feedback report includes two unused data transmitting sections, resulting in a waste of bandwidth. Offered is a feedback configuration that reports multiple carrier feedback in a single payload, resulting in improved throughput.

According to one aspect of the present disclosure, the UE transmission 718 may be configured to feedback CQI information of multiple carriers via a single HS-SICH payload. HS-SICH/TPC (transmit power code) information of multiple carriers may be bundled into one traditional HS-SICH transmission, thus reducing the SF-16 channel consumption by 50%. This transmission mechanism can be applied to both traditional HS-PDSCH transmission and CQI-request HS-SCCH transmission.

One aspect of mapping of two downlink carrier HS-SICHs to one traditional HS-SICH channel is shown in FIG. 8. The HS-SICH payload of the first carrier may be mapped according to the HS-SICH of FIG. 5. The HS-SICH payload 805 and 806 of the second carrier can be mapped to the unused data transmitting sections 508 and 509 of FIG. 5 on the channels during traditional HS-SICH transmission setup. Furthermore, the transmit power control (TPC) symbol which is targeted for power control of HS-SCCH₂ of carrier 2 may be remapped to the synchronization shift (SS) symbols 804 and 807 as uplink SS symbols are presently unused in TD-HSDPA systems. TPC symbols 604 and 607 are allocated for the first carrier. In this way, one traditional HS-SICH payload may be used to carry two feedback for two carriers, thereby reducing the channel consumption by 50% in a multicarrier HSPA system.

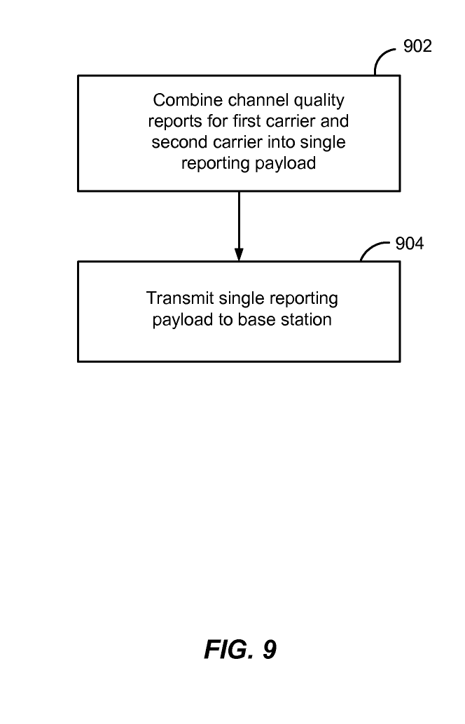

As shown in FIG. 9 a UE may combine channel quality reports for a first carrier and a second carrier into a single reporting payload, as shown in block 902. The UE may also transmit the single reporting payload to a base station, as shown in block 904.

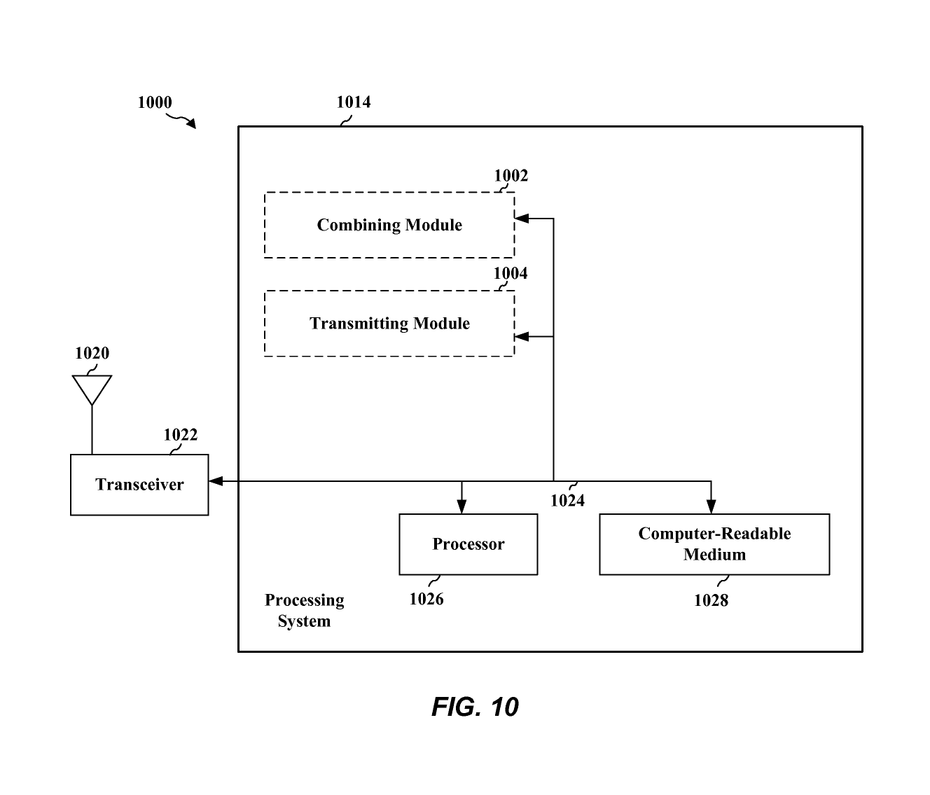

FIG. 10 is a diagram illustrating an example of a hardware implementation for an apparatus 1000 employing a processing system 1014. The processing system 1014 may be implemented with a bus architecture, represented generally by a bus 1024. The bus 1024 may include any number of interconnecting buses and bridges depending on the specific application of the processing system 1014 and the overall design constraints. The bus 1024 links together various circuits including one or more processors and/or hardware modules, represented by a processor 1026, a combining module 1002, a transmitting module 1004, and a computer-readable medium 1028. The bus 1024 may also link various other circuits such as timing sources, peripherals, voltage regulators, and power management circuits, which are well known in the art, and therefore, will not be described any further.

The apparatus includes the processing system 1014 coupled to a transceiver 1022. The transceiver 1022 is coupled to one or more antennas 1020. The transceiver 1022 provides a means for communicating with various other apparatus over a transmission medium. The processing system 1014 includes the processor 1026 coupled to the computer-readable medium 1028. The processor 1026 is responsible for general processing, including the execution of software stored on the computer-readable medium 1028. The software, when executed by the processor 1026, causes the processing system 1014 to perform the various functions described supra for any particular apparatus. The computer-readable medium 1028 may also be used for storing data that is manipulated by the processor 1026 when executing software. The processing system 1014 further includes the combining module 1002 for combining channel quality reports for a first carrier and a second carrier into a single reporting payload. The processing system 1014 further includes the transmitting module 1004 for transmitting the single reporting payload to a base station. The combining module 1002 and the transmitting module 1004 may be software modules running in the processor 1026, resident/stored in the computer readable medium 1028, one or more hardware modules coupled to the processor 1026, or some combination thereof. The processing system 1014 may be a component of the UE 350 and may include the memory 272 and/or the processor 270.

In one configuration, the apparatus 1000 for wireless communication includes means for combining. The means may be the combining module 1002 and/or the processing system 1014 of the apparatus 1000 configured to perform the functions recited by the measuring and recording means. As described above, the processing system 1014 may include the multicarrier module 391, the processor 1026, computer-readable medium 1028, controller/processor 390 and/or memory 392. In another aspect, the aforementioned means may be any module or any apparatus configured to perform the functions recited by the aforementioned means.

In one configuration, the apparatus 1000 for wireless communication includes means for transmitting. The means may be the transmitting module 1004 and/or the processing system 1014 of the apparatus 1000 configured to perform the functions recited by the means. As described above, the processing system 1014 may include the antennae 352/1020, transceiver 1022, processor 1026, computer-readable medium 1028, controller/processor 390, memory 392, transmit processor 380, and/or transmitter 356. In another aspect, the aforementioned means may be any module or any apparatus configured to perform the functions recited by the aforementioned means.

Several aspects of a telecommunications system has been presented with reference to TD-SCDMA systems. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of multicarrier wireless communication, comprising:
combining channel quality reports for a first carrier and a second carrier into a single reporting payload; and
transmitting the single reporting payload to a base station.

2. The method of claim 1, in which the single reporting payload comprises a High-Speed Shared Information Channel (HS-SICH) payload.

3. The method of claim 1, further comprising transmitting transmit power control (TPC) information of the second carrier using bits intended for synchronization shift (SS) information.

4. The method of claim 1, in which the single reporting payload comprises acknowledgement/negative-acknowledgement (ACK/NACK) information for the first carrier and second carrier.

5. The method of claim 1, in which the single reporting payload comprises channel quality index (CQI) information for the first carrier and second carrier.

6. An apparatus for multicarrier wireless communication, comprising:
means for combining channel quality reports for a first carrier and a second carrier into a single reporting payload; and
means for transmitting the single reporting payload to a base station.

7. The apparatus of claim 6, in which the single reporting payload comprises a High-Speed Shared Information Channel (HS-SICH) payload.

8. The apparatus of claim 6, further comprising means for transmitting transmit power control (TPC) information of the second carrier using bits intended for synchronization shift (SS) information.

9. The apparatus of claim 6, in which the single reporting payload comprises acknowledgement/negative-acknowledgement (ACK/NACK) information for the first carrier and second carrier.

10. The apparatus of claim 6, in which the single reporting payload comprises channel quality index (CQI) information for the first carrier and second carrier.

11. A computer program product, comprising:
a non-transitory computer-readable medium having non-transitory program code recorded thereon, the program code comprising:
program code to combine channel quality reports for a first carrier and a second carrier into a single reporting payload; and
program code to transmit the single reporting payload to a base station.

12. The computer program product of claim 11, in which the single reporting payload comprises a High-Speed Shared Information Channel (HS-SICH) payload.

13. The computer program product of claim 11, in which the program code further comprises program code to transmit power control (TPC) information of the second carrier using bits intended for synchronization shift (SS) information.

14. The computer program product of claim 11, in which the single reporting payload comprises acknowledgement/negative-acknowledgement (ACK/NACK) information for the first carrier and second carrier.

15. The computer program product of claim 11, in which the single reporting payload comprises channel quality index (CQI) information for the first carrier and second carrier.

16. An apparatus configured for wireless communication, comprising:
at least one processor; and
a memory coupled to said at least one processor,
wherein said at least one processor is configured:
to combine channel quality reports for a first carrier and a second carrier into a single reporting payload; and
to transmit the single reporting payload to a base station.

17. The apparatus of claim 16, in which the single reporting payload comprises a High-Speed Shared Information Channel (HS-SICH) payload.

18. The apparatus of claim 16, in which the at least one processor is further configured to transmit power control (TPC) information of the second carrier using bits intended for synchronization shift (SS) information.

19. The apparatus of claim 16, in which the single reporting payload comprises acknowledgement/negative-acknowledgement (ACK/NACK) information for the first carrier and second carrier.

20. The apparatus of claim 16, in which the single reporting payload comprises channel quality index (CQI) information for the first carrier and second carrier.
